(19) United States
(12) Patent Application Publication
(10) Pub. No.: US 2006/0101947 A1
(43) Pub. Date: May 18, 2006

(54) Cap removal implement

(76) Inventor: Samuel J. Pratt, Bedford, PA (US)

Correspondence Address: Peter N. Lalos;Stevens, Davis, Miller & Mosher, LLP, Suite 850, 1615 L Street, NW, Washington, DC, 20036-5622, US

(21) Appl. No.: 10/989,400

(22) Filed: Nov. 17, 2004

(51) Int. Cl. B67B 7/16

(52) U.S. Cl. 81/3.57; 81/3.55

(57) ABSTRACT

An implement for removing the cap of a container, having a top wall and a side wall provided with a peripheral edge, generally consisting of a body having a first surface engageable with an edge portion of the cap and a second surface engageable with a portion of the top wall of the cap, when the edge portion of the cap is engaged by the first surface of the body, permitting the body to be pivoted away from the container, utilizing the second surface of the body as a fulcrum, causing the lid to be pried off of the container; a counter supported on the body; and an element engageable by the cap when the cap engages the surfaces of the body and the body is pivoted relative to the container to pry the cap from the container, for actuating the counter to index a counting mechanism thereof.

This invention relates to an implement for removing caps from containers and more particularly to such an implement provided with means for tallying the number of such containers uncapped.

### BACKGROUND OF THE INVENTION

Many consumable beverages both alcoholic and non-alcoholic typically are distributed to commercial establishments and consumers in containers, usually metal cans or glass bottles, provided with caps which may be pried off with an implement commonly referred to as an “opener.” Such implements may be either of a hand held type or a wall mounted type. Often, commercial establishments in which such beverages are sold and consumed on the premises are required or desirous of tallying the number of such beverages being sold, perhaps for inventory or other commercial purposes. Monitoring the sale of such beverages by mentally keeping count or otherwise recording such count would be suitable for such purposes but may not be entirely accurate because of lapses in memory or forgetfulness in recording such count. It also may be desirous for consumers of such beverages to tally the number of such beverages consumed for recreational and other non-commercial purposes. Accordingly, it is the principal object of the present invention to provide an implement for removing the caps of containers which is operative to tally the number of such containers uncapped and presumably having the contents thereof consumed, for either commercial or recreational purposes.

### SUMMARY OF THE INVENTION

The principal objective of the present invention is achieved by means of an implement for removing the cap of a container, having a top wall and a side wall provided with a peripheral edge, generally consisting of a body having a first surface engageable with an edge portion of the cap and a second surface engageable with a portion of the top wall of such cap, when the side edge portion of the cap is engaged by the first surface of the body, permitting the body to be pivoted away from the container utilizing the second surface of the body as a fulcrum, causing the lid to be pried off of the container; a counter supported on the body; and an element engageable by the cap when the cap is engaged by the first surface of the body and the body is pivoted relative to the container to pry the cap from the container, for actuating the counter to index a counting mechanism thereof. The counter may be either mechanical or electrical and the body preferably is provided with a visual display of the count.

In another embodiment of the invention, the implement includes a body; and an electronic counter supported on the body having a circuit operative to actuate the indexing mechanism thereof, provided with a pair of spaced terminals insulated from the body, one of which is engageable with a portion of the top wall of the cap and the other of which is engageable with a portion of the edge of the cap, whereby upon engagement of such portion of the top wall of the cap with one of such terminals, engagement of the portion of the edge of the cap with the other of the terminals and the pivoting of the body relative to the container, the terminals of such circuit will be bridged, closing the electrical circuit and thus actuating the indexing mechanism of the counter, and the cap would be pried off of the container.

### BRIEF DESCRIPTION OF THE DRAWINGS

FIG. 1 is a perspective view of a cap removal implement embodying the present invention;

FIG. 2 is a side elevational view of the embodiment shown in FIG. 1;

FIG. 3 is a side view of the embodiment shown in FIGS. 1 and 2 illustrating the manner in which such implement is applied to a capped container for removal of the cap and recording the event of such removal;

FIG. 4 is a side elevational view of a modification of the embodiment shown in FIGS. 1 through 3;

FIG. 4a is a further modification of the implement shown in FIG. 4;

FIG. 5 is a view similar to the view shown in FIG. 3, illustrating the embodiment shown in FIG. 4 applied to a container with a cap for removing the cap from the container;

FIG. 6 is a perspective view of a further embodiment of the invention;

FIG. 7 is a side elevational view of the embodiment shown in FIG. 6;

FIG. 8 is a side elevational view of the embodiment shown in FIGS. 6 and 7, illustrating the manner in which the implement is applied to a capped bottle for removing the cap therefrom;

FIG. 9 is a perspective view of another embodiment of the invention;

FIG. 10 is a side elevational view of the embodiment shown in FIG. 9;

FIG. 11 is a side elevational view of the embodiment shown in FIGS. 9 and 10 illustrating the manner in which the implement is applied to a capped container for removing the cap thereof; and

FIG. 12 is a side elevational view of a still further embodiment of the present invention.

### DETAILED DESCRIPTION OF THE SEVERAL EMBODIMENTS OF THE INVENTION

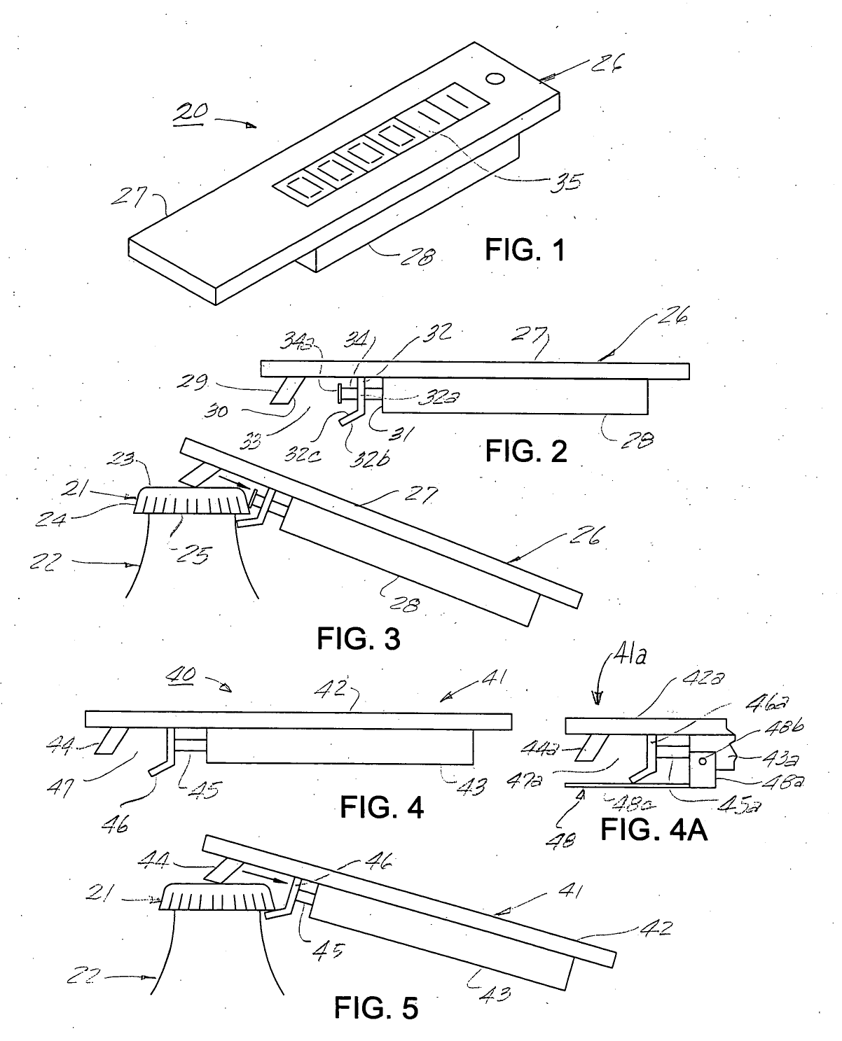

Referring to FIGS. 1 through 3 of the drawings, there is illustrated an implement 20 operable to pry off a cap 21 secured on the open end of a container 22 filled with a beverage or other content. Cap 21 is of a common type used to cap metal and glass containers and includes a top wall 23 and a side wall 24 having a substantially annular, lower edge 25. Implement 20 includes a body 26 having an upper, elongated section 27 and a lower section 28 depending from section 27 and having a length shorter than the length of section 27. Depending from section 27 and spaced from a forward end of body section 28 is a bracket 29 having an abutment surface 30 facing forwardly disposed surface 31 of body section 28. Disposed between bracket 29 and body section 28 and depending from body section 27 is a bracket 32 having a first portion 32a disposed substantially perpendicular to body section 27 and a portion 32b providing an abutment surface 32c, disposed at an acute angle relative to bracket portion 32a. The forward end of body section 27, depending bracket 29 and depending bracket 32 define a recess 33 which is adapted to receive a portion of a cap 21 attached to the upper end of a container 22 for prying such cap from the container in a manner as discussed below. Disposed within body 26 is a counter having an actuating rod 34 operatively connected to an indexing mechanism of the counter, and a visual display 35. Actuating rod 34 extends through an opening in bracket 32, is displaceable along the longitudinal centerline thereof and is biased in an extended position as shown in FIG. 2 by means of biasing mechanism contained in body section 28. The rod member further is provided with an abutment surface 34a which is spaced from abutment surface 32c and faces abutment surface 30.

The implement shown in FIGS. 1 and 2 may be used to remove a cap 21 from a container 22 by grasping container 22 in one hand, grasping the body portion of the implement in the other hand, maneuvering the implement so that a portion of cap 21 is received in recess 33, a portion of top wall 23 of the cap engages surface 30 or the lower inner edge of depending bracket 29, and a portion of lower cap edge 25 is opposed to abutment surface 32c, and then pivoting the implement away from the container while holding the container stationary, utilizing the contact of bracket 29 with the cap as a fulcrum so that abutment surface 32c will engage a portion of the cap edge and the cap will thus be pried off of the upper end of the container. As the cap is inserted into recess 33 and possibly as the implement is pivoted relative to the container, the side wall 24 of the cap will engage abutment surface 34a of actuating rod 34, causing it to displace along the longitudinal centerline thereof, against the force of the biasing mechanism, to actuate the indexing mechanism of the counter and thus record the uncapping of a container which is reflected in visual display 35.

The body portions of the implement may be formed of any rigid material including metallic materials, hard plastic materials or combinations of such materials. The counting device may consists of either mechanical or electrical counting devices, sufficiently miniaturized to preferably be embedded within the body of the implement and provide a visual display as shown in FIG. 1. The implement should have a sufficient length to provide a recess 33 for receiving a portion of a cap to be removed as shown in FIG. 3, and to permit the end of the implement opposite the end providing recess 33, to be grasped by a hand of the user for prying the cap off of the container.

Implement 40 shown in FIGS. 4 and 5 is comparable to implement 20 but utilizes a modified means for displacing the rod for actuating the indexing mechanism of the counter. Such implement includes a body 41 having an upper body section 42 comparable to body section 27, a depending body portion 43 comparable to body section 28, a depending bracket 44 comparable to bracket 29, a counter embedded in the body portion having an actuating rod 45 comparable to actuating rod 34 and a bracket 46 comparable to bracket 32 but unattached to body section 42 and attached to the free end of actuating rod 45. As in the previously described embodiment, a portion of upper body section 42, depending bracket 44 and bracket 46 cooperate to provide a recess 47 which is adapted to receive a portion of a cap 21 as shown in FIG. 5 for prying off the cap from the attached container. Implement 41 is utilized in essentially the same manner as implement 20 for prying off a cap 21 from a container 22. As in the previous description, container 22 is grasped with one hand and held stationary, implement 41 is grasped with the other hand and maneuvered to receive a portion of cap 21 within recess 47, and implement 41 is pivoted relative to container 22, utilizing the contact of bracket 44 with the top wall of the cap as a fulcrum, to cause bracket 46 to be engaged by a portion of the lower edge of the cap and thus pry the cap off of the container. As the implement is maneuvered to receive a portion of the cap within recess 47 and the implement is pivoted relative to the container, bracket 46 and correspondingly rod 45 will be displaced along the longitudinal centerline of the rod to actuate an indexing mechanism of the counter to record the uncapping event. Such uncapping event further is reflected in the visual display of the implement in the manner as described in connection with implement 20.

FIG. 4a illustrates a modification of implement 40 which also may be applied to the embodiment shown in FIGS. 1 through 3. The modification includes a body 41a comparable to body 41, a body section 42a comparable to body section 42, a body section 43a comparable to body section 43, a bracket 44a comparable to bracket 44, an actuating rod 45a comparable to rod 45 and a bracket 46a comparable to bracket 46, having various components thereof defining a recess 47a comparable to recess 47. To prevent the unintended or inadvertent entry of objects into recess 47a and thus engaging bracket 46a and displacing actuating rod 45a to result in a miscount, there is provided a shielding device 48 having a pair of depending arm portions 48a pivotally connected to side walls of body section 43a as at 48b, and an arm member 48c disposed substantially perpendicular to arm portions 48a. Arm portion 48c has a sufficient length and device 48 is bias in a manner whereby in the position as shown in FIG. 4a, arm portion 48a will preclude the unintentional or inadvertent entry of an object tending to displace actuating rod 45a yet is spaced sufficiently from the end of bracket 44a to permit the entry of a portion of a cap to be removed from a container in the manner as illustrated in FIG. 5. In the use of the embodiment shown in FIG. 4a for removing the cap on a container, the implement would be maneuvered to cause a portion of the cap to be received in the space between arm portion 48c and the end of bracket 44a, and then maneuvered to cause the cap portion to be received in recess 47a, causing device 48 to pivot away against the force of the biasing mechanism thereof.

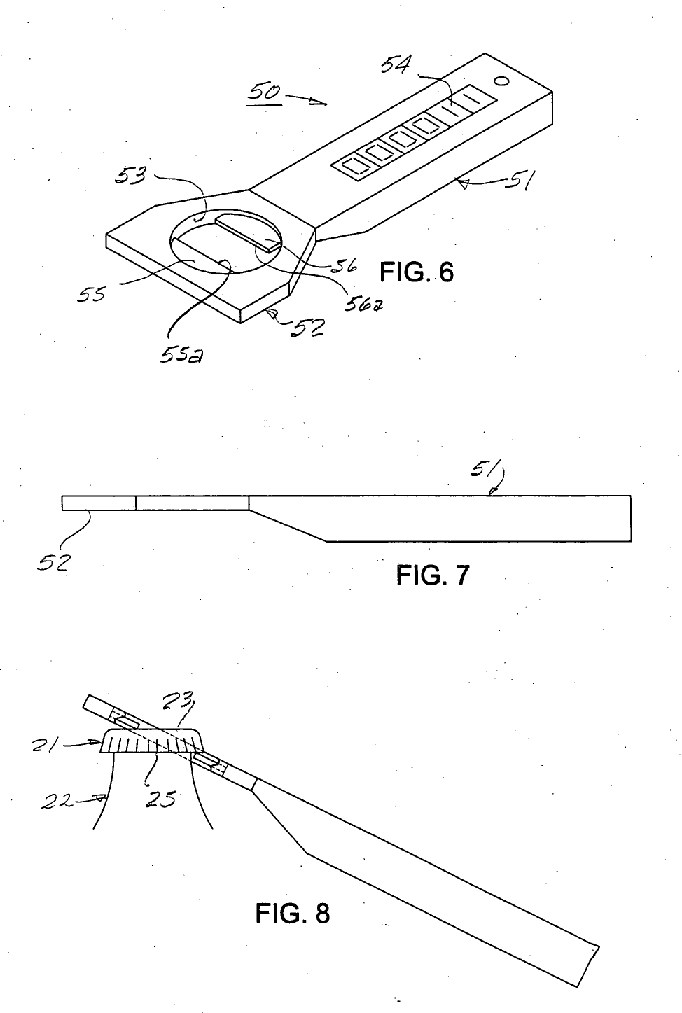

FIG. 6 through 8 illustrate another embodiment of the invention which essentially utilizes electrical means for sensing the removal of a cap from a container. The embodiment consists of an implement 50 having an elongated, main body section 51 and an extended, thinner body section 52 provided with a circular opening 53 therein having a diameter slightly greater than the diameter of a cap to be removed so that such cap may be partially received therethrough. Mounted in body section 51 is an electronic counter having an actuating circuit and a visual display 54. Such actuating circuit further is provided with a pair of spaced, conducting terminals 55 and 56 mounted in body section 52 and projecting within opening 53. In the use of implement 50 to remove a cap 21 from a container 22, the container is grasped in one hand and held stationary, body section 51 of the implement is grasped with the other hand, the implement is maneuvered to received a portion of cap 21 within opening 53 in body section 52 so that an edge 56a of terminal 56 engages a portion of peripheral edge 25 of the cap and edge 55a of terminal 55 engages a portion of upper wall 23 of the cap, and the implement is pivoted upwardly relative to the container utilizing the contact of terminal 55 with the upper wall of the capital as a fulcrum to pry the cap from the container. As the cap is received in opening 53 and engages terminals 55 and 56, the actuating circuit of the counter will be closed to thus index the counter and correspondingly record another uncapping of a container. Such uncapping will be reflected in visual display 54.

In the embodiment shown in FIGS. 6 through 8, terminals 55 and 56 would have to be insulated from the body of the implement. Preferably, the body of the implement would be formed of a hard plastic having sufficient strength to withstand the forces applied in prying off a cap from a container, and the electrical counter including the visual display and the actuating circuit and the unexposed portions of terminals 55 and 56 would be embedded in such material.

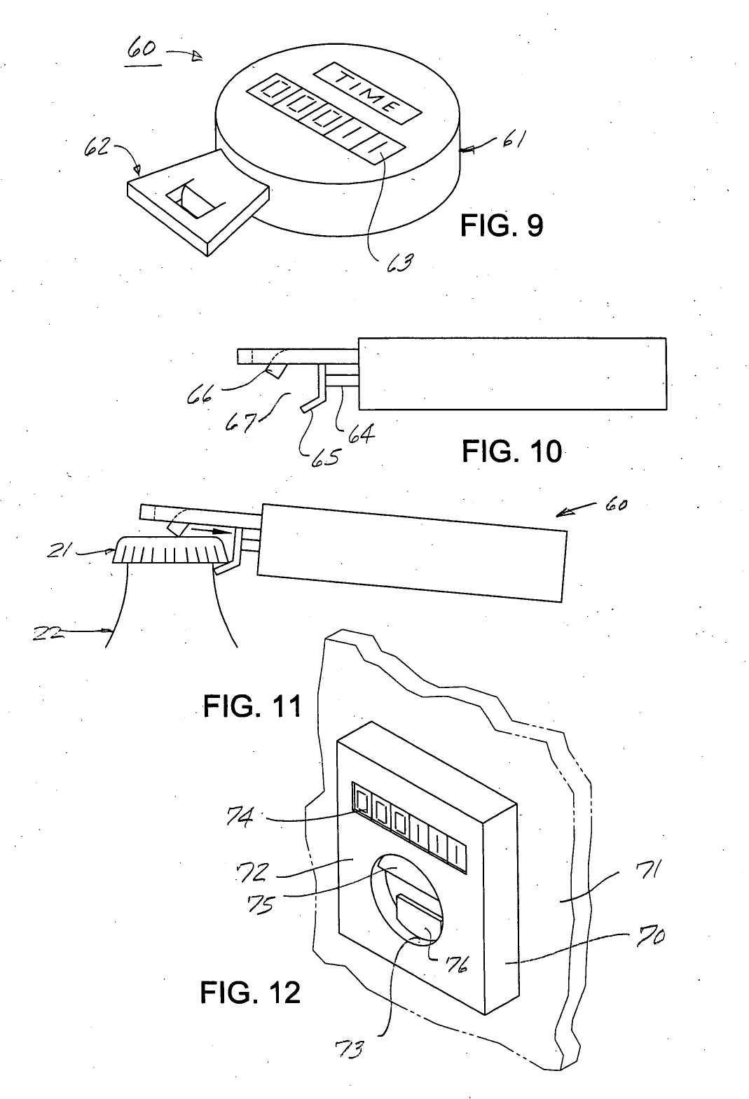

The embodiment of the invention shown in FIGS. 9 through 11 comprises a further modification of the embodiment shown in FIGS. 4 and 5. Such embodiment consists of an implement 60 having a main body section 61 and an extended body section 62. Main body section 61 may have a disc-shaped configuration which would house a counter device having a visual display 63. Such counter includes an actuating rod 64 having a cap engageable bracket 65 mounted on the end thereof comparable to actuating rod 45 and bracket 46, respectively. Body section 62 has a substantially planar configuration provided with a struck-out portion 66 which is disposed in opposed relation to bracket 65 and cooperates with a remaining portion of body section 62 and bracket 65 to define a recess 67 comparable to recess 47 of the implement shown in FIGS. 4 and 5.

As shown in FIG. 11, implement 61 may be utilized to remove a cap 21 of container 22 by grasping the container in one hand, grasping body section 61 of the implement in the other hand, maneuvering the implement to receive a portion of cap 21 within recess 67 so that a portion of the bottom edge of cap 21 engages bracket 65 and a portion of struck-out portion 66 engages the top wall of cap 21, and pivoting the implement upwardly away from the container, utilizing the engagement of struck out portion 66 with the top wall of the cap as a fulcrum, to pry the cap from the container. As in the previously described embodiment, as the cap is inserted in recess 67 and as the implement is pivoted relative to the container, actuating rod 64 will be displaced inwardly to actuate an indexing mechanism of the counter and thus record an uncapping of a container.

FIG. 12 illustrates a still further embodiment of the invention consisting of an implement 70 which may be mounted on a wall 71 or another vertical surface. The implement is substantially similar to the implement shown in FIGS. 6 through 8 and consists of a body 72 having a circular opening therein provided with a diameter slightly larger than the diameter of a cap to be removed from a container, and an electrical counter disposed within body 72 having a visual display 74 and an actuating circuit including a pair of terminals 75 and 76 extending into opening 73 and spaced apart, comparable to terminals 55 and 56 of previously described implement 50. Implement 70 may be utilized essentially in the same manner as implement 50 to remove the cap of a container except for having to grasp the implement in one hand. The implement may be used simply by grasping the container in one hand, inserting a portion of the cap into opening 73 between terminals 75 and 76, engaging one terminal with a portion of the edge of the side wall of the cap with one of the terminals, engaging a portion of the top wall of the cap with the other terminal and then pivoting the container relative to the stationary implement to pry the cap off of the container.

As previously indicated, the counter used in each of the embodiments of the invention may be mechanical, electrical or electromechanical. Preferably, the counter would be embedded within the body of the implement and would be provided with an exposed visual display to indicate the number of caps removed and correspondingly the number of container contents consumed. The counters may consist of any commercially available counters which perhaps may be modified with respect to the actuating mechanism to conform to their intended usage in the present invention. Examples of counters that may be utilized in the present invention are counters offered under the trademarks MINI-KAL and MICRO-KAL by Kessler Ellis Products of 10 Industrial Way East, Easton Town, N.J. 07724.

From the foregoing detailed description, it will be evident that there are a number of changes, adaptations, and modifications of the present invention which come within the province of those persons having ordinary skill in the art to which the aforementioned invention pertains. However, it is intended that all such variations not departing from the spirit of the invention be considered as within the scope thereof as limited solely by the appended claims.

I claim:

1. An implement for removing the cap of a container, having a top wall and a side wall provided with a peripheral edge, comprising:
a body having a first surface engageable with an edge portion of said cap and a second surface engageable with a portion of said top wall of said cap, when said edge portion of said cap is engaged by said first surface of said body, permitting said body to be pivoted away from said container, utilizing said second surface of said body as a fulcrum, causing said lid to be pried off of said container;
a counter supported on said body; and
an element engageable by said cap when said cap engages said surfaces of said body and said body is pivoted relative to the container to pry said cap from said container, for actuating said counter to index a counting mechanism thereof.

2. An implement according to claim 1 wherein said body is elongated.

3. An implement according to claim 1 wherein said body includes a recess provided between said first and second surfaces of said body.

4. An implement according to claim 1 wherein said body is elongated and includes a recess adjacent one end thereof providing said first and second surfaces of said body.

5. An implement according to claim 1 wherein said counter is disposed within said body.

6. An implement according to claim 1 wherein said counter includes a visual display.

7. An implement according to claim 1 wherein said counter is mechanical.

8. An implement according to claim 7 wherein said counter includes a visual display.

9. An implement according to claim 7 wherein said body is elongated.

10. An implement according to claim 7 wherein a first end of said body has a length sufficiently long to enable it to be grasped by the hand of a user, and a second end thereof includes said first and second surfaces of said body.

11. An implement according to claim 9 wherein said second end of said body includes a recess providing said first and second surfaces of said body.

12. An implement according to claim 7 wherein said body is provided with a hook having said first surface.

13. An implement according to claim 10 wherein said counter is disposed in said first end of said body.

14. An implement according to claim 1 wherein said counter is one of an electrical and electronic device.

15. An implement according to claim 14 wherein said counter includes a visual display.

16. An implement according to claim 14 wherein said body is elongated.

17. An implement according to claim 14 wherein a first end of said body has a length sufficiently long to enable it to be grasped by the hand of a user, and a second end thereof includes said first and second surfaces of said body.

18. An implement according to claim 17 wherein said second end of said body includes a recess providing said first and second surfaces of said body.

19. An implement according to claim 14 wherein said body is provided with a hook having said first surface.

20. An implement according to claim 14 wherein said counter is disposed in said first end of said body.

21. An implement for removing the cap of a container, having a top wall and a side wall provided with a peripheral edge, comprising:
a body having a first surface engageable with an edge portion of said cap and a second surface engageable with a portion of the top wall of said cap when said edge portion of said cap engages said first surface, permitting said container to be pivoted away from said first surface, utilizing said second surface as a fulcrum, causing said cap to be pried off of said body:
a counter supported on said body; and
a rod supported on said body, displaceable by said cap when said cap engages said first and second surfaces, and operatively connected to said counter for indexing a counting mechanism thereof when displaced.

22. An implement according to claim 21 wherein a first end of said body has a configuration sufficient to allow a user to grasp the body with a hand, and a second end of said body includes said first and second surfaces.

23. An implement according to claim 21 wherein said counter includes a visual display.

24. An implement according to claim 21 including means shielding said rod for preventing the unintentional displacement thereof.

25. An implement according to claim 21 wherein said counter is mechanical.

26. An implement according to claim 21 wherein said counter is one of an electrical and electronic device.

27. An implement for removing the cap of a container, having a top wall and a side wall provided with a peripheral edge, comprising:
a body having a contact portion engageable with the top wall of said cap; and
a counter supported on said body having an actuating rod displaceable along a line of travel between an extended position and a retracted position operable at a selected point along said line of travel to index said counter;
said rod being biased in said extended position and having a contact surface disposed in a plane lying at an acute angle relative to said line of travel whereby when the top wall of said cap is engaged by said contract portion of said body, a portion of said edge of said cap is engaged by said contact surface of said rod member and said body is pivoted relative to said container, utilizing said engagement of said cap with said contact portion of said body as a fulcrum, said rod member will be displaced along its line of travel to index said counter and cause said cap to be pried off of said container.

28. An implement according to claim 27 wherein a first end of said body has a configuration sufficient to allow a user to grasp the body with a hand, and a second end of said body includes said first-mentioned contact surface.

29. An implement according to claim 27 wherein said counter includes a visual display.

30. An implement according to claim 27 including means shielding said rod for preventing the unintentional displacement thereof.

31. An implement according to claim 27 wherein said counter is mechanical.

32. An implement according to claim 27 wherein said counter is one of an electrical and electronic device.

33. An implement for removing an electrically conducting cap of a container, having a top wall and a side wall provided with a peripheral edge, comprising:
a body; and
an electronic counter supported on said body having a circuit operative to actuate the indexing mechanism thereof, provided with a pair of spaced terminals insulated from said body, one of which is engageable with a portion of the top wall of said cap and the other of which is engageable with a portion of said edge of said cap, whereby upon engagement of said portion of said top wall of said cap by one of said terminals, engagement of said portion of said edge of said cap by the other of said terminals and the pivoting of said body relative to said container, said contacts will be bridged, closing said electrical circuit and thereby actuating the indexing mechanism of said counter, and said cap shall be pried off of said container.

34. An implement according to claim 33 wherein said body is provided with an opening therein, and said terminals comprise spaced metallic plates disposed in said opening, accessible by the cap on a container inserted into said opening.

35. An implement according to claim 33 wherein a first end of said body has a configuration sufficient to allow a user to grasp the body with a hand, and a second end of said body includes said spaced terminals.

36. An implement according to claim 33 wherein said counter includes a visual display.
